(19) United States
(12) Patent Application Publication
(10) Pub. No.: US 2005/0289306 A1
(43) Pub. Date: Dec. 29, 2005

(54) Memory read requests passing memory writes

(76) Inventors: Sridhar Muthrasanallur, Tumwater, WA (US); Kenneth C. Creta, Gig Harbor, WA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/879,778

(22) Filed: Jun. 28, 2004

(51) Int. Cl. G06F 12/00

(52) U.S. Cl. 711/158

(57) ABSTRACT

Memory read and write requests are received. The read is received in accordance with a communication protocol that has a transaction ordering rule in which a memory read cannot pass a memory write. The memory read and write requests are forwarded to the first device in accordance with another communication protocol that has a transaction ordering rule in which a memory read may pass a memory write. The forwarded memory read request is allowed to pass the forwarded memory write request whenever a relaxed ordering flag in the received read request is asserted. Other embodiments are also described and claimed.

### BACKGROUND

An embodiment of the invention is related to the processing of memory read and memory write requests in computer systems having both strong and relaxed transaction ordering. Other embodiments are also described.

A computer system has a fabric of several devices that communicate with each other using transactions. For example, a processor (which may be part of a multi-processor system) issues transaction requests to access main memory and to access I/O devices (such as a graphics display adapter and a network interface controller). The I/O devices can also issue transaction requests to access locations in a memory address map (memory read and memory write requests). There are also intermediary devices that act as a bridge between devices that communicate via different protocols. The fabric also has queues in various places, to temporarily store requests until resources are freed up before they are propagated or forwarded.

To ensure that transactions are completed in the sequence intended by the programmer of the software, strong ordering rules may be imposed on transactions that move through the fabric at the same time. However, this safe approach generally hampers performance in a complex fabric. For example, consider the scenario where a long sequence of transactions is followed by a completely unrelated one. If the sequence makes slow progress, then it significantly degrades the performance of the device waiting for the unrelated transaction to complete. For that reason, some systems implement relaxed ordering where certain transactions are allowed to bypass earlier ones.

However, consider a system whose fabric uses the Peripheral Components Interconnect (PCI) Express communications protocol, as described in PCI Express Base Specification 1.0a available from PCI-SIG Administration, Portland, Oreg. The PCI Express protocol is an example of a point to point protocol in which memory read requests are not allowed to pass memory writes. In other words, in a PCI Express fabric, a memory read is not allowed to proceed until an earlier memory write (that will share a hardware resource, such as a queue, with the memory read) has become globally visible. Globally visible means any other device or agent can access the written data.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” embodiment of the invention in this disclosure are not necessarily to the same embodiment, and they mean at least one.

FIG. 1 shows a block diagram of a computer system whose fabric in based on a point-to-point protocol such as PCI Express, and on a cache coherent protocol with relaxed ordering.

FIG. 2 shows a flow diagram of a more generalized method for processing memory read and write transactions using a relaxed ordering flag.

FIG. 3 shows a block diagram of another embodiment of the invention.

FIG. 4 illustrates a flow diagram of a method for processing read and write transactions without reliance on the relaxed ordering flag.

### DETAILED DESCRIPTION

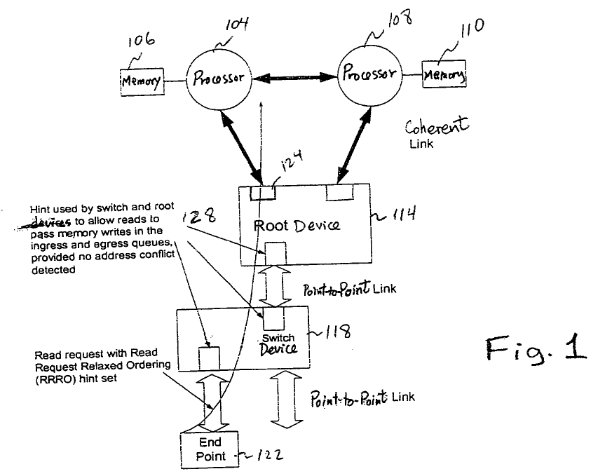

Beginning with FIG. 1, a block diagram of an example computer system whose fabric is in part based on a point-to-point protocol such as the PCI Express protocol is shown. The system has a processor 104 that is coupled to a main memory section 106 (which in this example consists of mostly dynamic random access memory, DRAM, devices). The processor 104 may be part of a multi-processor system, in this case having a second processor 108 that is also coupled to a separate main memory section 110 (consisting of mostly, once again DRAM devices). Memory devices other than DRAM may alternatively be used. The system also has a root device 114 that couples the processor 104 to a switch device 118. The root device is to send transaction requests on behalf of the processor 104 in a downstream direction, that is away from the root device 114. The root device 114 also sends memory requests on behalf of an endpoint 122. The endpoint 122 may be an I/O device such as a network interface controller, or a disk controller. The root device 114 has a port 124 to the processor 104 through which memory requests are sent. This port 124 is designed in accordance with a cache coherent point-to-point communication protocol having a somewhat relaxed transaction ordering rule that a memory read may pass a memory write. The port 124 may thus be said to be part of a coherent point-to-point link that couples the root device 114 to the processor 104 or 108.

The root device 114 also has a second port 128 to the switch device 118, through which transaction requests may be sent and received. The second port 128 is designed in accordance with a point-to-point communication protocol that has a relatively strong transaction ordering rule that a memory read cannot pass a memory write. An example of such a protocol is the PCI Express protocol. Other communication protocols having similar transaction ordering rules may alternatively be used. The root device also has an ingress queue (not shown) to store received memory read and memory write requests that are directed upstream, in this case coming from the switch device 118. An egress queue (not shown) is provided to store memory read and memory write requests that are to be sent to the processor 104.

In operation, consider for example, that the endpoint 122 originates a memory read request that propagates or is forwarded by the switch device 118 to the root device 114 which in turn forwards the request to, for example, the processor 104. According to an embodiment of the invention, the memory read request packet is provided with a relaxed ordering flag (also referred to as a read request relaxed ordering hint, RRRO). The endpoint 122 may have a configuration register (not shown) that is accessible to a device driver running in the system (being executed by the processor 104). The register has a field that, when asserted by the device driver, permits the endpoint 122 to set the RRRO hint or flag in the packet, prior to transmission of the read request packet, if it may be expected that out of order processing of the memory read is tolerable. Logic (not shown) may be provided in the root device 114, to detect this relaxed ordering flag in the memory read request and in response allow the request to pass one or more previously enqueued memory write requests in either an ingress or egress queue. This reordering should only be allowed if the logic finds no address conflict between the memory read and any memory writes that are to be passed. If there is an address conflict, then the read and write requests are kept in source-originated order, to ensure that the read will obtain any previously written data. By reordering, the switch device 118 or the root device 114 will move that transaction ahead of the previously enqueued memory write requests that are directed upstream.

The memory read and write requests may target a main memory section 106 or 110. Such requests are, in this embodiment, handled by logic within the processor 104 or 108. This may include an on-chip memory controller (not shown) that is used to actually access, for example, a DRAM device in the main memory section 106, 110. The above-described embodiment of the invention may help reduce read request latency (which can be particularly high when the memory is “integrated” with the processor as in this case), by relaxing the ordering requirements on memory read requests originating from I/O devices. This may be particularly advantageous in a system having a full duplex point-to-point system interface according to the PCI Express protocol that has strong ordering, and a coherent point-to-point link used to communicate with the processors 104, 108 and that has relaxed ordering. That is because strong transaction ordering on memory read requests may lead to relatively poor utilization of, for example, the coherent link in the outbound or downstream direction (that is, the direction taken by read completions, from main memory 106, 110 to the requestor). Thus, even though the switch device 118 has interfaces to point-to-point links that have strong transaction ordering rules, at least with respect to a memory read request not being allowed to pass a memory write, the switch device 118 and the root device 114 may be modified in accordance with an embodiment of the invention to actually implement relaxed ordering as described here, with respect to a memory read that has a relaxed ordering flag or hint asserted.

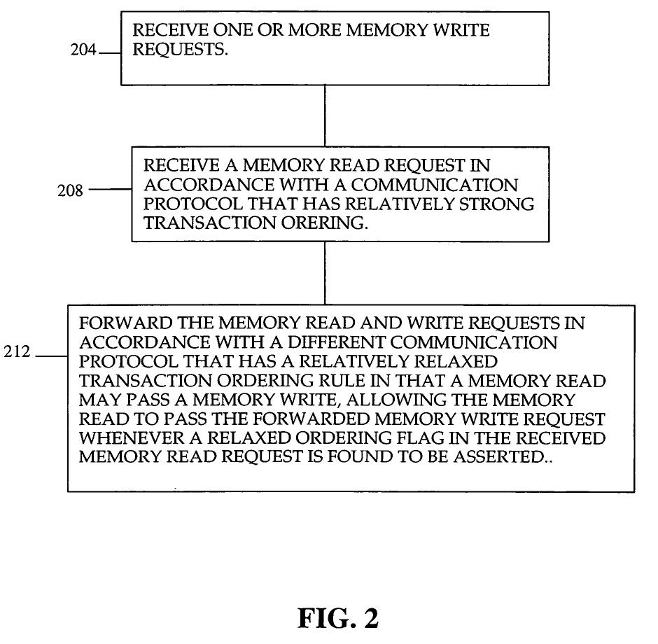

Turning now to FIG. 2, a flow diagram of a more generalized method for processing memory read and write transactions using a relaxed ordering flag is shown. The operations may be those that are performed by, for example, the root device 114. Operation begins with receiving one or more memory write requests that target a first device (block 204). These write requests may, for example, be part of posted transactions in that the transaction consists only of a request packet transmitted uni-directionally from requester to completer with no completion packet returned from completer to requester. The targeted first device may be a main memory section 106 or 110 (see FIG. 1). This is followed by receiving a memory read request that may also target the first device (208). The read request may, for example, be part of a non-posted transaction that implements a split transaction model where a requestor transmits a request packet to the completer, and the completer returns a completion packet (with the requested data) to the requestor. More particularly, the read request is received in accordance with a communication protocol that has a relatively strong transaction ordering rule in that a memory read cannot pass a memory write. An example of such a protocol is the PCI Express protocol.

The memory read and memory write requests are to be forwarded to the first device in accordance with a different communication protocol that has a relatively relaxed transaction ordering rule in that a memory read may pass a memory write (212). The method is such that the forwarded memory read request is allowed to pass the forwarded memory write request whenever a relaxed ordering flag in the received memory read request is found to be asserted. Note that this should only be allowed if there is no address conflict between the passing memory read and the memory write that is being passed. An address conflict is when two transactions access the same address at the same time.

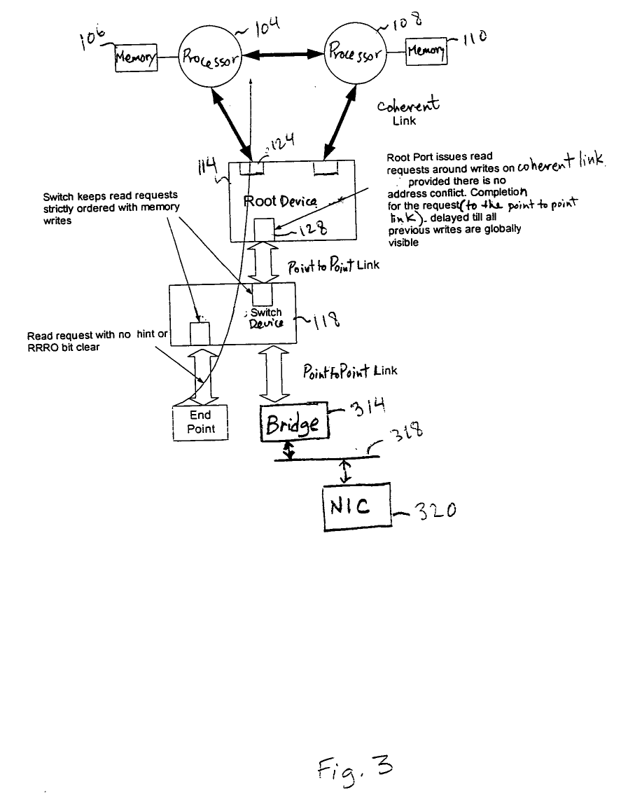

Turning now to FIG. 3, a block diagram of another embodiment of the invention is shown. In this case, the switch device 118 keeps read requests strictly ordered with memory writes and there is no hint or RRRO flag set in the received read request packet. It is the root device 114 that is enhanced with logic (not shown) that allows the received memory read request to actually pass a request for a memory write that has been enqueued in one of its ingress and egress queues, provided there is no address conflict. Thus, the root device 114 in effect has blanket permission to reorder the read requests around previously enqueued writes, on the coherent link that connects with the processor 104, 108. However, in this embodiment, it may be necessary to deal with so-called legacy flush semantics that could have been intended with the read request. For example, the read request could have originated from a legacy I/O device, such as a network interface controller (NIC 320) that resides on a legacy multi-drop bus 318. A bridge 314 serves to propagate the read request over the point-to-point link to the switch device 118, and onto the root device 114 before being passed on to the processor 104 or 108. In that case, the legacy flush semantics may require a guarantee that the memory read not pass any memory write in the same direction. This is designed to ensure that there is no risk of reading incorrect data (due to a location in memory being accessed prior to the earlier write having updated the contents of that location).

According to another embodiment of the invention, to preserve flush semantics from the standpoint of software that is using the NIC 320, the root device 114 is designed to deliver the completion packet of the memory read request to its requester (here the NIC 320) over the point-to-point link to the switch device 118, only if all earlier memory writes (sharing certain hardware resources, such as an ingress or egress queue, with the read request) have become globally visible. In this case, a memory write sent to the processor over the coherent link is globally visible when the root device 114 receives an acknowledgement (ack) packet from the accessed main memory section 106 or 110, in response to the memory write having been applied. This ack packet is a feature of the coherent link which may be used to indicate global visibility. Thus, the root device 114 holds or delays the read completions received from main memory, until all previous pending writes (sharing resources with the read request) are globally visible.

To implement legacy flush semantics, a requestor (such as the NIC 320) may follow a sequence of memory write requests by sending a read. That is because the memory write transactions, be it on the legacy bus 318 or the point-to-point link (e.g., PCI Express interface), do not call for a completion packet to be returned to the requestor. The only way that such a requestor can find out whether its earlier write requests have actually reached main memory is to follow these with the read (which may be directed at the same address as the writes, or a different one). The read, in contrast to the write, is a non-posted transaction, such that a completion packet (whether containing data or not) is returned to the requestor once the read request has been applied at the target device. Using such a mechanism, a requestor can confirm to its software that the sequence of writes have, in fact, completed, because by definition, in the legacy and the point-to-point link interfaces, the read should not pass the earlier writes. This means that if the read completion has been received, the software will assume that all earlier writes have reached their target devices.

An advantage of the above-described technique for delaying the forwarding of read completions to the requestor may be appreciated by the following example. Assume the endpoint in this case the NIC 320 is a legacy network adapter card that is retrieving data from a network (e.g., the Internet) and writing this data to main memory. A long sequence of writes are therefore generated by the NIC 320 which are forwarded over the point-to-point links between the bridge and the switch device and between the switch device and the root device. In that case, these writes are posted in the sense that no completion packet is to be returned to the requestor. To preserve legacy flush semantics, the NIC 320 follows the last write request with a memory read request. Assume next that the NIC 320 waits for the read completion packet in response to which it immediately interrupts the processor on a sideband line or pin (not shown). This interrupt is designed to signal the processor that the data collected from the network is now in memory and should be processed according to an interrupt service routine, for example, in the device driver routine corresponding to the NIC 320. This device driver routine will assume that all data from the previous writes have already been written to main memory and, as such, will attempt to read that data. Note that the interrupt is relatively fast because of the sideband pin that is available, such that there is a relatively short delay between receiving the completion packet in the NIC 320 and the device driver starting to read data from main memory. Accordingly, in such a situation, if the read completion packet is received by the NIC 320 too soon, namely before all of the write data has been written to main memory, then incorrect data may be read since the write transactions have not finished. Thus, it can be appreciated that if the root device delays the forwarding of the read completion packet (over the point-to-point link to the switch device 118) until the ack packet is received for the last memory write from the main memory (over the coherent link), then the device driver software for the NIC 320 is, in fact, guaranteed to read the correctly updated data in response to the interrupt.

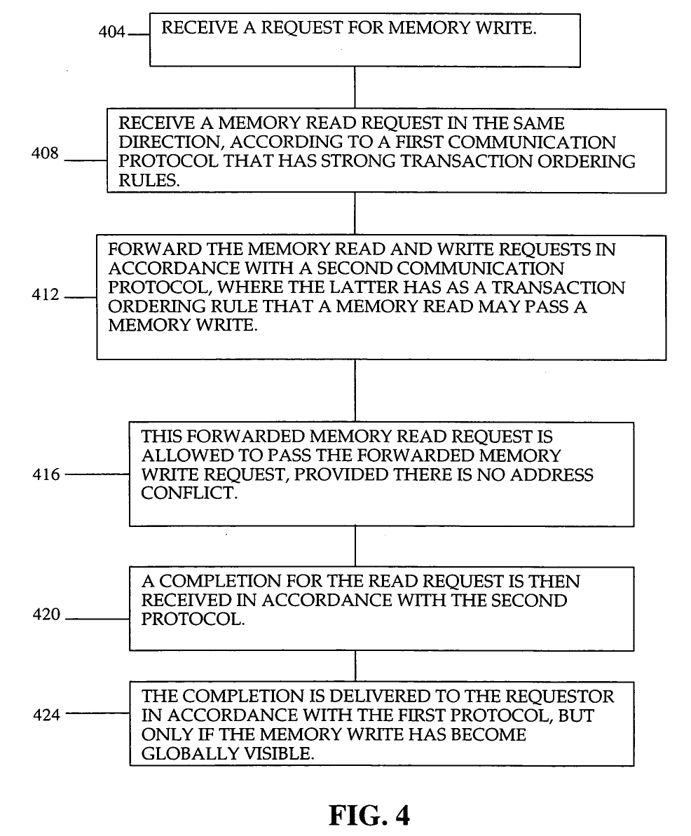

Turning now to FIG. 4, a more general method for processing read and write transactions without reliance on a relaxed ordering hint is depicted. Operation begins with receiving a request for memory write (block 404), followed by receiving a memory read request in the same direction (block 408). These requests may be from the same requester. The read request is received in accordance with a point-to-point communication protocol that has a transaction ordering rule that a memory read cannot pass a memory write. Operation then proceeds with forwarding the memory read and write requests in accordance with a second communication protocol, where the latter has as a transaction ordering rule that a memory read may pass a memory write (block 412). This forwarded memory read request is allowed to pass the forwarded memory write request, provided there is no address conflict (block 416). A completion for the read request is then received in accordance with the second protocol (block 420). Finally, the completion is delivered to the requestor in accordance with the first protocol, but only if the memory write has become globally visible (block 424). As an example, the memory write may be considered globally visible when the root device 114 (see FIG. 3) receives an ack packet from main memory section 106 (as part of a non-posted write transaction over the coherent link). By delaying the return of the completion in this way, until all previous memory writes in the same direction as the read are globally visible, legacy flush semantics that may be required at the requestor can be satisfied.

Although the above examples may describe embodiments of the present invention in the context of logic circuits, other embodiments of the present invention can be accomplished by way of software. For example, in some embodiments, the present invention may be provided as a computer program product or software which may include a machine or computer-readable medium having stored thereon instructions (e.g., a device driver) which may be used to program a computer (or other electronic devices) to perform a process according to an embodiment of the invention. In other embodiments, operations might be performed by specific hardware components that contain microcode, hardwired logic, or by any combination of programmed computer components and custom hardware components.

A machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, a transmission over the Internet, electrical, optical, acoustical or other forms of propagated signals (e.g., carrier waves, infrared signals, digital signals, etc.) or the like.

Further, a design may go through various stages, from creation to simulation to fabrication. Data representing a design may represent the design in a number of manners. First, as is useful in simulations, the hardware may be represented using a hardware description language or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, data representing a hardware model may be the data specifying the presence or absence of various features on different mask layers for masks used to produce the integrated circuit. In any representation of the design, the data may be stored in any form of a machine-readable medium. An optical or electrical wave modulated or otherwise generated to transmit such information, a memory, or a magnetic or optical storage such as a disc may be the machine readable medium. Any of these mediums may “carry” or “indicate” the design or software information. When an electrical carrier wave indicating or carrying the code or design is transmitted, to the extent that copying, buffering, or re-transmission of the electrical signal is performed, a new copy is made. Thus, a communication provider or a network provider may make copies of an article (a carrier wave) embodying techniques of the present invention.

The invention is not limited to the specific embodiments described above. For example, although the coupling between the root device and the processor, in some embodiments, is referred to as a coherent, point-to-point link, an intermediate device such as a cache coherent switch may be included in between the processor and the root device. In addition, in FIG. 1, the processor 104 may be replaced by a memory controller node, such that requests targeting the main memory section 106 are serviced by a memory controller node rather than a processor. Accordingly, other embodiments are within the scope of the claims.

1. A method for processing memory read and write transactions, comprising:
receiving a memory write request; and then
receiving a memory read request, wherein the read request is received in accordance with a first communication protocol having as a transaction ordering rule that a memory read cannot pass a memory write; and
forwarding the memory read and write requests in accordance with a second communication protocol having as a transaction ordering rule that a memory read may pass a memory write,
wherein the forwarded memory read request is allowed to pass the forwarded memory write request whenever a relaxed ordering flag in the received memory read request is asserted.

2. The method of claim 1 wherein the received memory write and read requests target main memory.

3. The method of claim 2 wherein the forwarded memory read request is allowed to pass the forwarded memory write request only if there is no address conflict between them.

4. The method of claim 2 wherein the received memory read and write requests originate from the same endpoint.

5. The method of claim 2 wherein the second protocol is a cache coherent, point to point protocol for communication between a system chipset and a plurality of processors.

6. The method of claim 5 wherein the first protocol is a point to point protocol with strong transaction ordering.

7. The method of claim 5 wherein the first protocol is a PCI Express protocol.

8. An apparatus comprising:
a root device to couple a processor to an I/O fabric containing an I/O device, the root device to send transaction requests on behalf of the processor and to send memory requests on behalf of the I/O device,
the root device having a first port to the processor through which the memory requests are sent, the first port being designed in accordance with a coherent point to point communication protocol having a transaction ordering rule that a memory read may pass a memory write, and a second port to the I/O fabric through which the transactions requests are sent, the second port being designed in accordance with a point to point communication protocol having a transaction ordering rule that a memory read cannot pass a memory write, p1 the root device having an ingress queue to store memory read and memory write requests from the I/O fabric, and an egress queue to store memory read and memory write requests to be sent to the processor; and
logic to detect a relaxed ordering flag in a received memory read request from the I/O device and in response allow said received memory read request to pass a memory write request that is stored in one of the ingress and egress queues.

9. The apparatus of claim 8 wherein said point to point communication protocol is a PCI Express protocol.

10. The apparatus of claim 8 wherein said point to point communication protocol defines a full duplex path with a plurality of bidirectional serial lanes.

11. An apparatus comprising:
a switch device to bridge an upstream device to a downstream device,
the switch device having a first port to the upstream device and an egress queue to store transaction requests directed upstream, the first port being designed in accordance with a point to point communication protocol having a transaction ordering rule that a memory read cannot pass a memory write,
and a second port to the downstream device and an ingress queue to store transaction requests directed upstream, the second port being designed in accordance with said protocol; and
logic to detect a relaxed ordering flag in a received memory read request that is directed upstream and in response allow said received memory read request to pass a memory write request that is in one of the ingress and egress queues.

12. The apparatus of claim 11 wherein said point to point communication protocol is a PCI Express protocol.

13. The apparatus of claim 11 wherein said point to point communication protocol defines a full duplex path with a plurality of bidirectional serial lanes.

14. A system comprising:
a processor;
main memory to be accessed by the processor;
a switch device to bridge with an I/O device; and
a root device coupling the processor to the switch device,
the root device having a first port through which memory requests that target the main memory and that are on behalf of the I/O device are sent, the first port being designed in accordance with a coherent point to point communication protocol having a transaction ordering rule that a memory read may pass a memory write, and a second port to the switch device through which transactions requests are sent on behalf of the processor, the second port being designed in accordance with a point to point communication protocol having a transaction ordering rule that a memory read cannot pass a memory write,
the root device having an ingress queue to store received memory read and memory write requests coming from the switch device, and an egress queue to store memory read and memory write requests to be sent to the main memory; and
logic to detect a relaxed ordering flag in a memory read request from the I/O device and in response allow said memory read request to pass a memory write request that is stored in one of the ingress and egress queues.

15. The system of claim 14 wherein the switch device has a first port to the root device and an egress queue to store memory read and write requests directed upstream, the first port being designed in accordance with said point to point communication protocol,
and a second port to the I/O device and an ingress queue to store memory read and write requests from the I/O device, the second port being designed in accordance with said point to point communication protocol; and
logic to detect the relaxed ordering flag in said memory read request and in response allow said memory read request to pass a memory write request that is in one of the ingress and egress queues of the switch device.

16. The system of claim 15 wherein said point to point communication protocol is a PCI Express protocol.

17. The system of claim 15 further comprising a memory controller node coupling the root device to the main memory in accordance with the coherent point-to-point communication protocol.

18. The system of claim 15 in combination with the I/O device being a network adapter card from which said memory read request containing the relaxed ordering flag is to originate.

19. The system of claim 18 further comprising a bridge coupling the second port of the switch to the network adapter card, and wherein the network adapter card is a PCI legacy device.

20. A method for processing read and write transactions, comprising:
receiving a request for a memory write; and then
receiving a memory read request, wherein the read request is received in accordance with a first communication protocol having as a transaction ordering rule that a memory read cannot pass a memory write; and then
forwarding the memory read and write requests in accordance with a second communication protocol having as a transaction ordering rule that a memory read may pass a memory write, wherein the forwarded memory read request is allowed to pass the forwarded memory write request provided there is no address conflict; and then
receiving a completion for the read request in accordance with the second protocol; and then
delivering the completion to the requester in accordance with the first protocol only if the memory write has become globally visible.

21. The method of claim 20 wherein the memory write and read requests target main memory.

22. The method of claim 21 wherein the memory read and write requests originate from the same endpoint.

23. The method of claim 22 wherein the second protocol is a cache coherent, point to point protocol for communication between a system chipset and a plurality of processors.

24. The method of claim 23 wherein the first protocol is a point to point protocol with strong transaction ordering.

25. The method of claim 23 wherein the first protocol is a PCI Express protocol.

26. An apparatus comprising:
a root device to couple a processor to an I/O fabric containing an I/O device, the root device to send transaction requests on behalf of the processor and to send memory requests on behalf of the I/O device,
the root device having a first port to the processor through which the memory requests are sent, the first port being designed in accordance with a coherent point to point communication protocol having a transaction ordering rule that a memory read may pass a memory write, and a second port to the I/O fabric through which the transaction requests are sent, the second port being designed in accordance with a point to point communication protocol having a transaction ordering rule that a memory read cannot pass a memory write,
the root device having an ingress queue to store memory read and memory write requests from the I/O fabric, and an egress queue to store memory read and memory write requests to be sent to the processor, and
logic to allow a received memory read request to pass a request for a memory write that is stored in one of the ingress and egress queues provided there is no address conflict, and to deliver a completion for said memory read request to its requester in accordance with the point to point protocol only if the memory write has become globally visible.

27. The apparatus of claim 26 wherein said point to point communication protocol is a PCI Express protocol.

28. The apparatus of claim 26 wherein said point to point communication protocol defines a full duplex path with a plurality of serial lanes in each direction.

29. A system comprising:
a processor;
main memory to be accessed by the processor;
a switch device to bridge with an I/O device; and
a root device coupling the processor to the switch device,
the root device having a first port through which memory requests that target the main memory and that are on behalf of the I/O device are sent, the first port being designed in accordance with a coherent point to point communication protocol having a transaction ordering rule that a memory read may pass a memory write, and a second port to the switch device through which transactions requests on behalf of the processor are sent, the second port being designed in accordance with a point to point communication protocol having a transaction ordering rule that a memory read cannot pass a memory write,
the root device having an ingress queue to store received memory read and memory write requests coming from the switch device, and an egress queue to store memory read and memory write requests to be sent to the main memory; and
logic to allow a received memory read request to pass a request for a memory write that is stored in one of the ingress and egress queues provided there is no address conflict, and to deliver a completion for said memory read request to its requester in accordance with the point to point protocol only if the memory write has become globally visible.

30. The system of claim 29 wherein said point to point communication protocol is a PCI Express protocol.

31. The system of claim 29 further comprising a memory controller node coupling the root device to the main memory in accordance with the coherent point-to-point protocol.

32. The system of claim 29 wherein the switch device implements strong transaction ordering including a transaction ordering rule that a memory read request cannot pass a memory write request in the same direction.

33. The system of claim 29 in combination with the I/O device being a network adapter card from which said received memory read request is to originate.

34. The system of claim 33 further comprising a bridge coupling the switch device to the network adapter card, and wherein the network adapter card is a legacy device having a sideband pin to interrupt the processor.

35. An apparatus comprising:
an integrated circuit device having a link interface designed in accordance with a point to point communication protocol having a transaction ordering rule that a memory read cannot pass a memory write in the same direction, wherein the device has a configuration register, accessible to a device driver, with a field that when asserted by the device driver permits the device to assert a relaxed ordering hint in a field of a memory read request packet it initiates through the link interface.

36. The apparatus of claim 35 wherein the integrated circuit device is a network interface controller.

37. The apparatus of claim 35 wherein the integrated circuit device is a graphics display controller.

38. The apparatus of claim 35 wherein the link interface is designed in accordance with the PCI Express protocol.

39. An article of manufacture comprising:
a machine-accessible medium containing instructions that, when executed, cause a machine to assert a field of a configuration register of an I/O device having a link interface designed in accordance with a point to point communication protocol, the protocol having a transaction ordering rule that a memory read cannot pass a memory write in the same direction, wherein the field when asserted permits the I/O device to assert a relaxed ordering hint in a field of a memory read request packet it initiates through the link interface.

40. The article of claim 39 wherein the instructions are part of a device driver for a network interface controller.

41. The article of claim 39 wherein the instructions are part of a device driver for a graphics display controller.

42. A method for processing memory read and write requests, comprising:
receiving from a requestor a plurality of memory write requests followed by a memory read request, over an I/O link that has a transaction ordering rule that a memory read not pass a memory write in the same direction;
forwarding to main memory the requests over a cache coherent link that has a transaction ordering rule that a memory read may pass a memory write in the same direction; and
forwarding to the requestor a completion packet, corresponding to said read request, over the I/O link, wherein the completion packet appears in the I/O link before a last one of the plurality of write requests has reached the main memory.

43. The method of claim 42 wherein the I/O link is a PCI Express link.

44. The method of claim 42 wherein the requestor is an I/O device having a sideband pin to interrupt a processor.

45. A method for processing memory read and write requests, comprising:
receiving a memory write request followed by a memory read request, over an I/O link that has a transaction ordering rule that a memory read not pass a memory write in the same direction;
forwarding the requests to main memory over a cache coherent link that has a transaction ordering rule that a memory read may pass a memory write in the same direction;
receiving an acknowledge packet, that was sent in response to the memory write request, over the cache coherent link;
receiving a completion packet, that was sent in response to the memory read request, over the cache coherent link; and
forwarding the completion packet over the I/O link, wherein the completion packet appears in the I/O link before the acknowledge packet appears in the cache coherent link.

46. The method of claim 45 wherein the memory write and read requests are received from the same requester.

47. The method of claim 45 wherein the requestor is an I/O device.

48. The method of claim 47 wherein the I/O link is a PCI Express link.
